(19) United States
(12) Patent Application Publication
(10) Pub. No.: US 2012/0017489 A1
(43) Pub. Date: Jan. 26, 2012

(54) Bobber Lure System

(76) Inventor: David E. Partridge, Defuniak Springs, FL (US)

(21) Appl. No.: 12/842,498

(22) Filed: Jul. 23, 2010

(51) Int. Cl. A01K 85/00

(52) U.S. Cl. 43/42.39; 43/42.49

(57) ABSTRACT

An artificial fishing bait combining the features of a traditional lure with those of a bobber. The lure body is made of a buoyant material. A weight is included proximate the head. A hook attachment point is provided near the mouth position in the head. A line attachment point is provided in the tail. A hook of any suitable design is attached to the hook attachment point. A line is attached to the line attachment point. The buoyancy and the mass of the materials used to create the lure are selected so that the assembly floats in a head-down orientation. When the lure is in use, the user observes the tail as he or she would conventionally observe a bobber. When a fish is engaging the hook(s), the tail will bob up and down. The user may then jerk the rod upward to set the hook.

### BACKGROUND OF THE INVENTION

1. Field of the Invention

This invention relates to the field of sporting goods. More specifically the invention comprises a fish lure designed to mimic the appearance of a dead bait fish floating near the surface of the water while performing the function of a bobber.

2. Description of the Related Art

Fishing bait is broadly classified as “live” and “artificial.” The term “live bait” generally refers to things which are actually eaten by the fish, which includes live creatures such as crickets and inert foodstuffs such as cheese. For the case of inert foodstuffs, it is well known in the art to suspend the foodstuff beneath a float known as a “bobber.”

FIG. 1 depicts one such prior art device. Line 12 is attached to bobber 18 at line attachment point 22. The opposite end of line 20 is connected to a fishing rod. Bobber 18 is made buoyant by using a naturally buoyant material (such as a light foam) or by including entrapped air pockets.

Hook 10 is suspended beneath bobber 18 by any conventional means. The embodiment shown includes two pieces of leader 16 connected by a swivel 14. One end of this assembly is attached to bobber 18 at leader attachment point 24. The other end of the assembly is attached to hook 10. Bait 12 is placed on hook 10 to attract a fish.

The operation of this device is well known. The bobber floats on the surface and becomes very still. However, when a fish begins to nibble the bait, the bobber bobs up and down. The bobber's exterior is conventionally provided with a very bright color so that the user can easily perceive the bobbing motion. Thus alerted, the user jerks upward on the fishing rod in an attempt to set hook 10 in the fish's mouth.

Many different types of bobbers are known in the prior art. Some bobbers actually clamp directly to the line so that a single piece of line extends from the rod all the way to the hook. This type of configuration does not need the swivel or leader pieces. However, the operation of the bobber (in terms of catching a fish) is the same.

Artificial baits traditionally operate on different principles. FIG. 2 shows a representative artificial bait—crank bait 26. This type of artificial bait is intended to be pulled through the water by cranking a fishing reel. It simulates a swimming bait fish. Body 28 generally resembles the shape of a bait fish. Diving plane 34 causes the bait to dive when reeled toward the rod. One or more hooks 10 are attached to body 28. These are typically attached to the aft end of the body and/or the ventral region.

Decorative features of varying complexity are often added, such as eye 30 and gill decoration 32. These generally attempt to mimic the features of a bait fish species, and may even include a complex and reflective pattern of scales.

Line 20 is attached to the crank bait using swivel 14 and leader 16. Towing anchor 36 is the attachment point. By reeling in line 20, crank bait 26 is urged through the water in a manner which resembles a swimming bait fish.

The present invention seeks to merge the bait fish mimicking features of an artificial bait with the fish strike-sensing advantages of a bobber.

### BRIEF SUMMARY OF THE INVENTION

The present invention comprises an artificial fishing bait combining the features of a traditional lure with those of a bobber. The lure body is made of a buoyant material. The body is shaped to resemble a bait fish, including a head and a tail. A weight is included proximate the head. A hook attachment point is provided near the mouth position in the head. A line attachment point is provided in the tail.

A hook of any suitable design is attached to the hook attachment point. A line is attached to the line attachment point. The buoyancy and the mass of the materials used to create the lure are selected so that the assembly floats in a head-down orientation. That is, the head points downward into the water. The buoyancy and mass are also selected so that substantially all of the tail protrudes above the water. The tail is preferably colored brightly so that it may be easily seen.

When the lure is in use, the user observes the tail as he or she would conventionally observe a bobber. When a fish is engaging the hook(s), the tail will bob up and down. The user may then jerk the rod upward to set the hook.

### BRIEF DESCRIPTION OF THE SEVERAL VIEWS OF THE DRAWINGS

FIG. 1 is a perspective view, showing a prior art bobber assembly

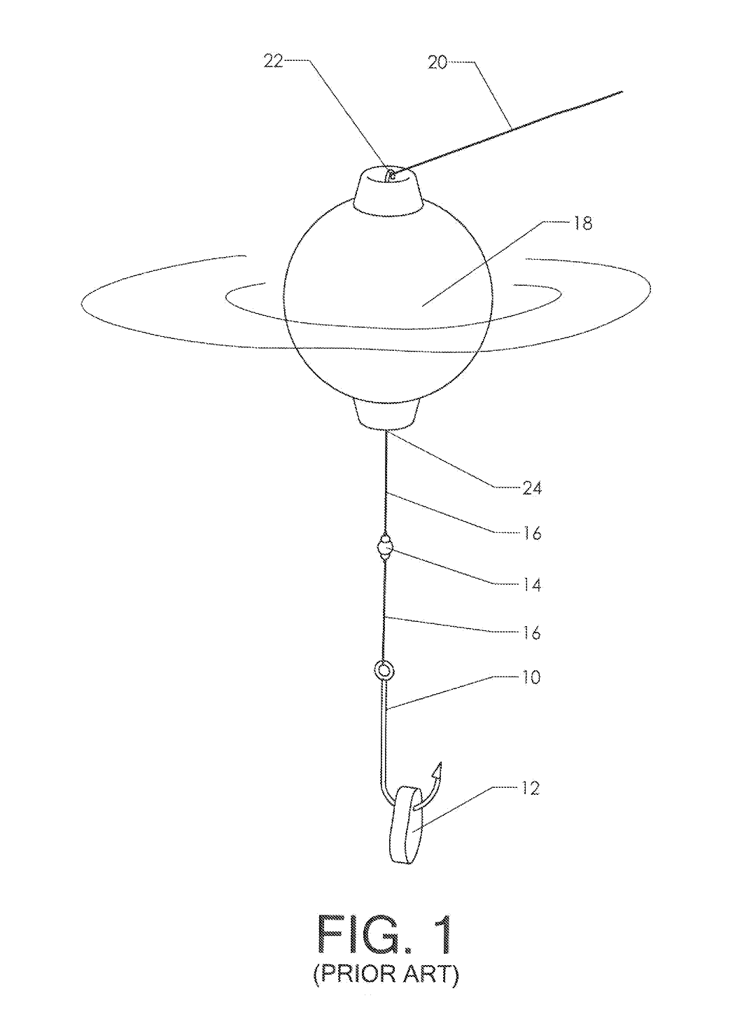

FIG. 2 is a perspective view, showing a prior art crank bait.

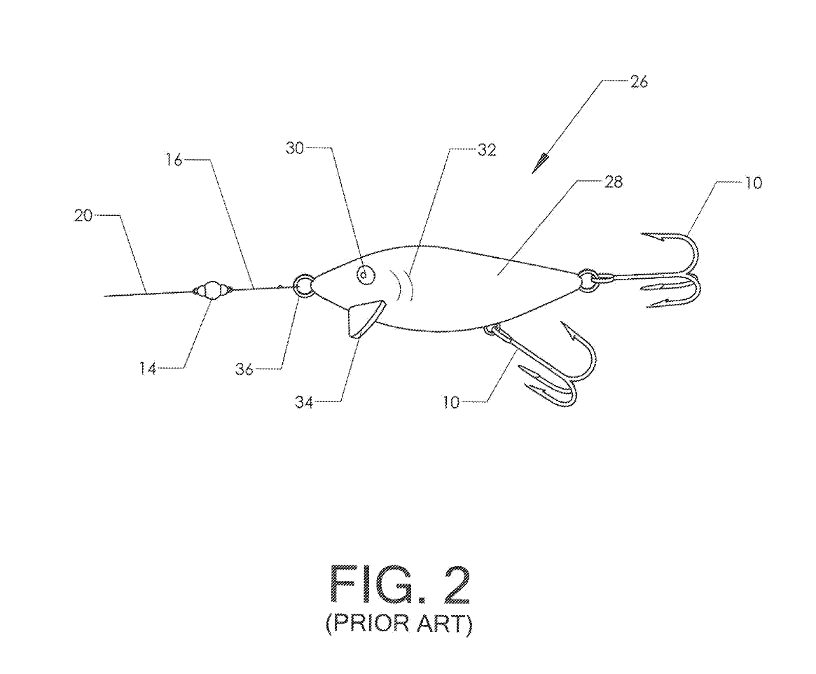

FIG. 3 is a perspective view showing the present invention.

FIG. 4 is a perspective view, showing the present invention in operation.

FIG. 5 is a perspective view with a cutaway, showing the present invention with the head portion cut away to reveal the presence of an internal weight.

FIG. 6 is a perspective view, showing the operation of the present invention.

FIG. 7 is a perspective view, showing an alternate embodiment of the present invention.

### REFERENCE NUMERALS IN THE DRAWINGS

| | | | |
|---|---|---|---|
| 10 | hook | 12 | bait |
| 14 | swivel | 16 | leader |
| 18 | bobber | 20 | line |
| 22 | line attachment point | 24 | leader attachment point |
| 26 | crank bait | 28 | body |
| 30 | eye | 32 | gill decoration |
| 34 | diving plane | 36 | towing anchor |
| 38 | bobber lure | 40 | head |
| 42 | tail | 44 | hook attachment point |
| 46 | water surface | 48 | reinforced foam |
| 50 | weight | 52 | bright region |
| 54 | auxiliary hook attachment point | | |
| 56 | aft intersection | 58 | mouth |

### DETAILED DESCRIPTION OF THE INVENTION

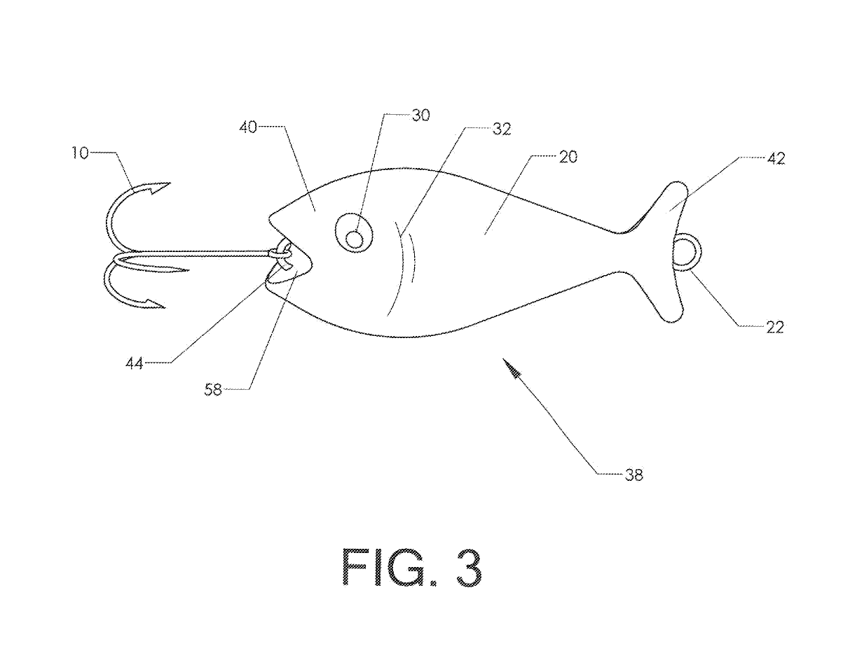

FIG. 3 shows the present invention as a complete assembly. Bobber lure 38 includes body 20. The body is shaped to resemble a baitfish, as for the prior art. Decorative features such as eye 30 and gill decoration 32 are also included. Any known feature from prior artificial baits may be included on the body as well—such as detailed scale patterns.

Body 12 has head 40 on one end and tail 42 on the opposite end. Hook attachment point 44 is provided proximate the head, and line attachment point 22 is provided proximate the tail. It is preferably to provide hook attachment point 44 in mouth 58—though the inclusion of a mouth feature is not essential to the present invention. The hook and line attachment points are typically loops of stiff wire having a portion of the loop embedded in the lure body and a portion extending outside of the lure body. Such devices are well known to those skilled in the art and—as they do not form a part of the novelty of the present invention—they will not be described in further detail.

A hook of any suitable known design may be used with the bobber lure. In the embodiment shown, a treble hook 10 is attached to hook attachment point 44 in any conventional fashion. Those skilled in the art will at this point realize that the location of the hook and the line attachment points have been reversed in comparison to the prior art. It is conventional to attach the line near the lure's head and attach the hook near the tail. These points have been reversed in the present invention.

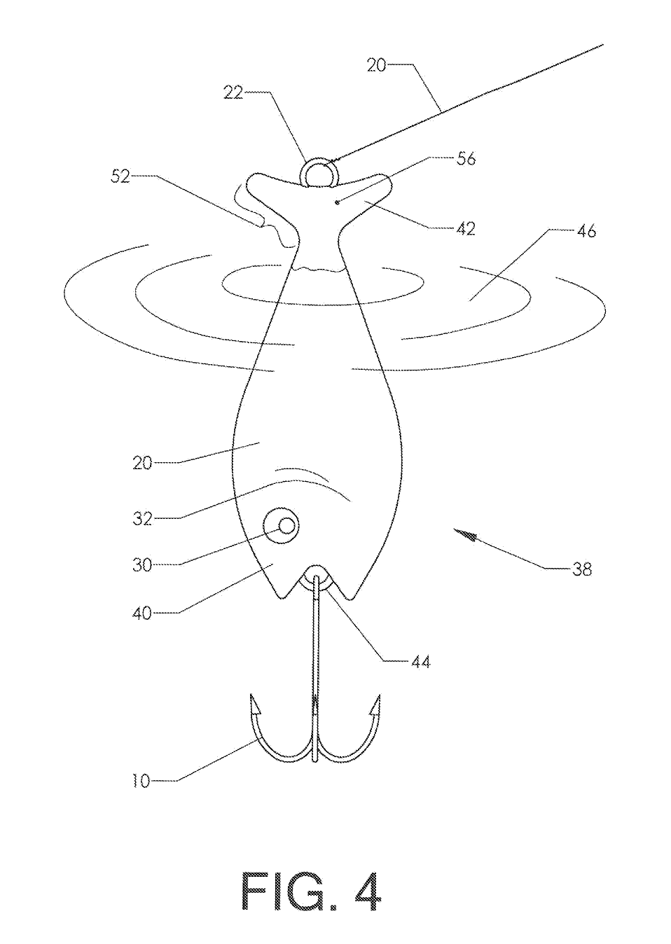

Body 20 is provided with a variable density so that it will float in a specific orientation. FIG. 4 shows bobber lure 38 floating. Water surface 46 is indicated. The lure assembly (including the hook and all components) must have an average specific gravity less than 1.0. This fact ensures that bobber lure 38 will float with a portion protruding above water surface 46. However, the specific gravity of the overall lure design is made variable so that the lure, will float in the “head down” orientation shown.

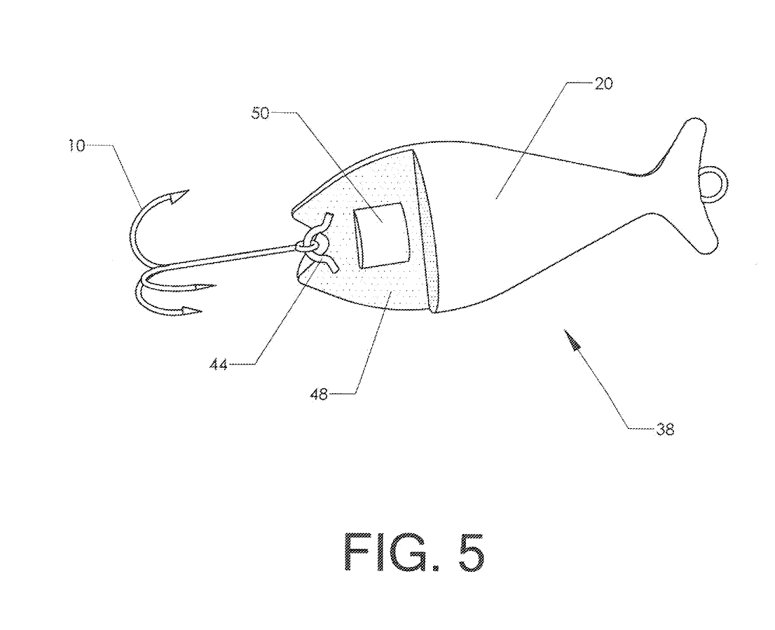

The variation in specific gravity may be achieved using a variety of different approaches. One approach is to make the lure body of a relatively uniform, buoyant material. A suitable weight is then added in the head portion. FIG. 5 shows a perspective cutaway view of this option. Body 20 is molded of reinforced foam 48 (a strong but buoyant material). Weight 50 is added in the head portion so that the specific gravity of the head portion becomes greater than 1.0. The weight is preferably sized according to the overall mass of the bobber lure—which includes the mass of the hook selected. In other words, it is preferable to match a particular weight 50 to the mass of a particular hook in order to give the desired characteristics overall.

The result is a lure assembly which floats as shown in FIG. 4. When viewed from below and from the side (as is the case for the view of a predatory fish), bobber lure 38 appears to be a dead or distressed baitfish. Tail 42 is preferably provided with a bright region 52. This bright region stands out in contrast to the surrounding water so that the user may easily visualize motion of the visible portion. A baitfish tail typically includes a dorsal extension and a ventral extension, which meet at aft intersection 56. Line attachment point 22 is preferably provided at aft intersection 56 so that the line will be held above the water at the point where it joins the bobber lure.

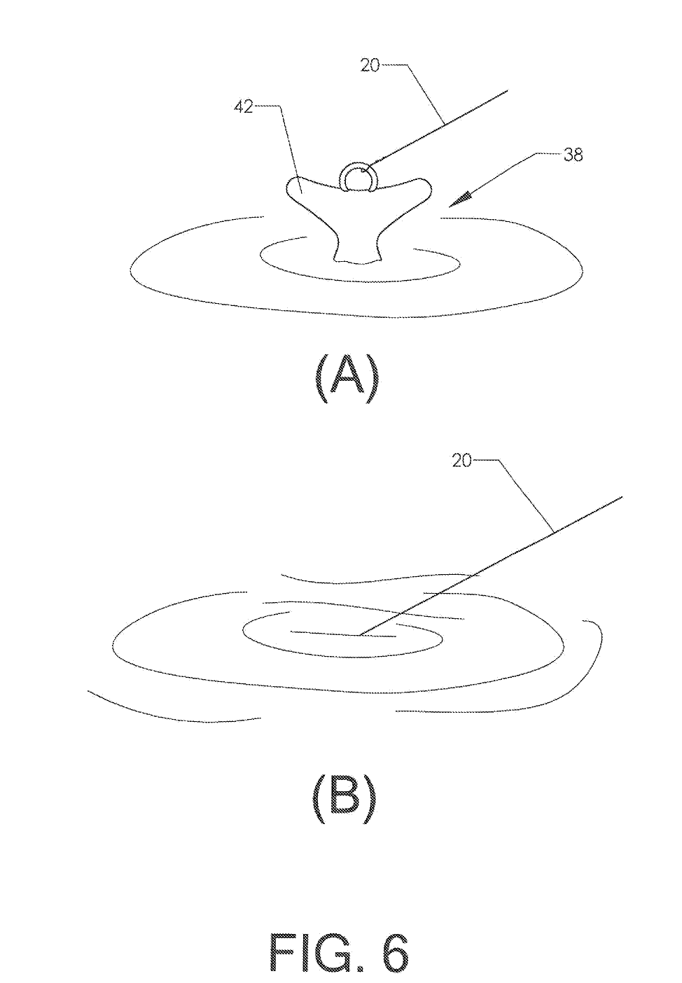

The operation of the bobber lure is shown in FIGS. 6(A) and 6(B). In FIG. 6(A), bobber lure 38 is floating in an undisturbed state. Tail 42 is clearly visible to the user. When a fish strikes or nibbles at the bobber lure, the tail will plunge beneath the water as shown in FIG. 6(B). The user is thereby alerted to jerk the rod tip upward in order to set the hook.

The bobber lure is quite sensitive in its motion. A fish nudging the hook or lure body will cause the bobber lure to bob up and down. This action gives the user the chance to snag a fish even when the fish has not attempted to swallow the bobber lure.

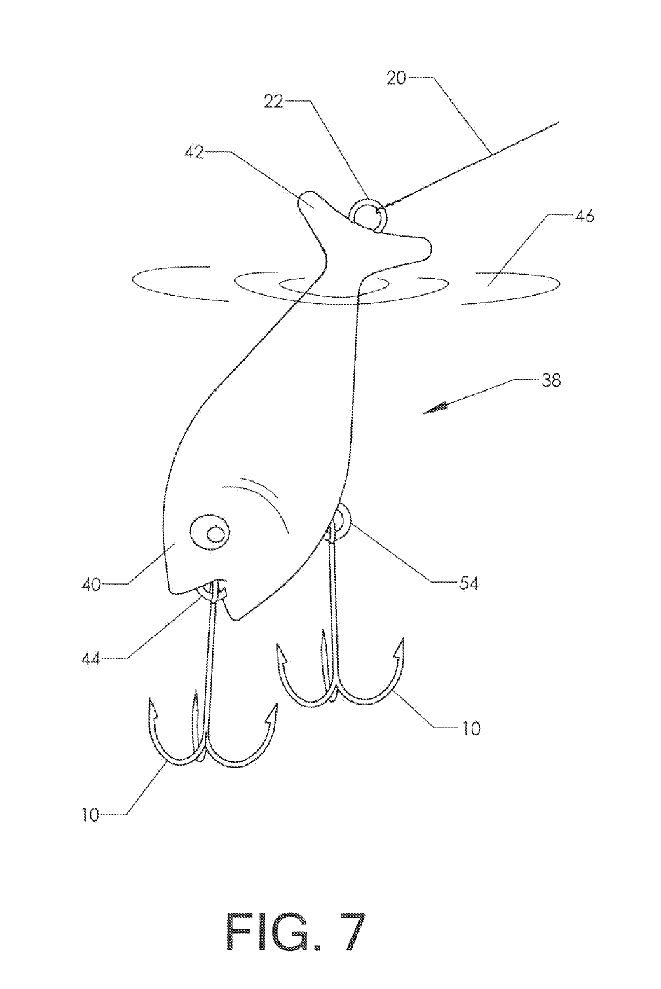

FIG. 7 shows an alternate embodiment incorporating the same basic features. Auxiliary hook attachment point 54 has been provided in the ventral position of the lure body. A second hook 10 is attached to this auxiliary hook attachment point.

If a weight in the head is used to create the desired variation in specific gravity, the weight is preferably selected with the weight of the two hooks 10 in mind, so that the overall specific gravity of the lure assembly is correct. The reader will observe that this particular embodiment floats in an inclined orientation rather than a substantially vertical one. However, tail 42 still protrudes above water surface 46 in order to perform the desired indicating function.

There are other ways to create the desired variation in specific gravity between the head and the tail of the lure body. One approach is to externally affix a weight to the head. As second approach is to use a single material for the lure body, but vary its density from the head to the tail. Foaming thermoplastics are suitable for this second approach. Those skilled in the art will know that some thermoplastics have a specific gravity that is greater than 1.0. However, small air bubbles can be injected into these thermoplastics during the molding process in order to reduce the density. The addition of the air bubbles produces a cellular structure similar to bone.

The amount of air injected causes a variation in the cell size of the foam, and a resulting variation in density. A mold can be gated near the head of the lure body so that the plastic flowing into the mold fills the tail first and the head last. A significant quantity of air is injected in the first part of the mold cycle so that the tail has a lower density. This produces the desired “head down” floating characteristic.

The preceding description contains significant detail regarding the novel aspects of the present invention. It should not be construed, however, as limiting the scope of the invention but rather as providing illustrations of the preferred embodiments of the invention. As an example, single “J-hooks” could be substituted for the treble hooks shown in the illustrations. As a second example, two or more weights could be added in the head portion in order to carefully regulate the overall buoyancy of the bobber lure and even adjust the inclination (or lack thereof) of the body's long axis while floating in the “head down” orientation. Thus, the scope of the invention should be fixed by the following claims, rather than by the examples given.

1. A fishing lure assembly, comprising:
a. a lure body having a head and a tail;
b. said lure body being made of a buoyant material;
c. a hook attachment point located on said head;
d. a line attachment point located on said tail;
e. a hook attached to said hook attachment point;
f. a weight located within said lure body proximate said head; and
g. wherein the mass of said weight and the buoyancy of said lure body material are selected so that said lure body floats in a head-down orientation with said tail protruding above the water surface.

2. A fishing lure assembly as recited in claim 1, wherein said lure body includes eye and gill decorations mimicking the appearance of a bait fish.

3. A fishing lure assembly as recited in claim 1, further comprising:
a. an auxiliary hook attachment point on said lure body; and
b. a second hook attached to said auxiliary hook attachment point.

4. A fishing lure assembly as recited in claim 1, further comprising:
a. a mouth; and
b. wherein said hook attachment point is located in said mouth.

5. A fishing lure assembly as recited in claim 1, wherein said tail is brightly colored.

6. A fishing lure assembly as recited in claim 1, wherein:
a. said tail includes a dorsal portion, a ventral portion, and an aft intersection therebetween; and
b. said line attachment point is located proximate said aft intersection.

7. A fishing lure assembly as recited in claim 6, wherein said tail is brightly colored.

8. A fishing lure assembly comprising:
a. a lure body having a head and a tail;
b. said lure body being made of buoyant material;
c. a weight permanently attached to said lure body proximate said head;
d. a hook attachment point located on said head;
e. a line attachment point located on said tail;
f. a hook attached to said hook attachment point; and
g. wherein the mass of said weight and the buoyancy of said lure body material are selected so that said lure body floats in a head-down orientation with said tail protruding above the water surface and said hook dangling beneath said lure body.

9. A fishing lure assembly as recited in claim 8, wherein said lure body includes eye and gill decorations mimicking the appearance of a bait fish.

10. A fishing lure assembly as recited in claim 8, further comprising:
a. an auxiliary hook attachment point on said lure body; and
b. a second hook attached to said auxiliary hook attachment point.

11. A fishing lure assembly as recited in claim 8, further comprising:
a. a mouth; and
b. wherein said hook attachment point is located in said mouth.

12. A fishing lure assembly as recited in claim 8, wherein said tail is brightly colored.

13. A fishing lure assembly as recited in claim 8, wherein:
a. said tail includes a dorsal portion, a ventral portion, and an aft intersection therebetween; and
b. said line attachment point is located proximate said aft intersection.

14. A fishing lure assembly as recited in claim 13, wherein said tail is brightly colored.

15. A fishing lure assembly comprising:
a. a lure body having a head and a tail;
b. wherein said lure body has variable density, with said head being more dense than said tail;
c. a hook attachment point located on said head;
d. a line attachment point located on said tail;
e. a hook attached to said hook attachment point; and
f. wherein the variable density of said lure body is selected so that said lure body floats in a head-down orientation with said tail protruding above the water surface and said hook dangling beneath said lure body.

16. A fishing lure assembly as recited in claim 15, wherein said lure body includes eye and gill decorations mimicking the appearance of a bait fish.

17. A fishing lure assembly as recited in claim 15, further comprising:
a. an auxiliary hook attachment point on said lure body; and
b. a second hook attached to said auxiliary hook attachment point.

18. A fishing lure assembly as recited in claim 15, further comprising:
a. a mouth; and
b. wherein said hook attachment point is located in said mouth.

19. A fishing lure assembly as recited in claim 15, wherein said tail is brightly colored.

20. A fishing lure assembly as recited in claim 15, wherein:
a. said tail includes a dorsal portion, a ventral portion, and an aft intersection therebetween; and
b. said line attachment point is located proximate said aft intersection.
